(19) United States
(12) Patent Application Publication
(10) Pub. No.: US 2016/0111781 A1
(43) Pub. Date: Apr. 21, 2016

(54) SYSTEM FOR GENERATION AND MANAGEMENT OF ORBITAL ANGULAR MOMENTUM IN AN ELECTROMAGNETIC RADIATION BY MEANS OF SPECIAL LENS

(71) Applicant: Marco Celso MATTEONI, Turin (IT)

(72) Inventors: Marco Celso Matteoni, Turin (IT); Gianni Santarelli, Arezzo (IT); Fabrizia Di Mascio, Monte San Savino (IT); Mario Burigo, Monte San Savino (IT)

(21) Appl. No.: 14/895,197

(22) PCT Filed: Jun. 30, 2014
(86) PCT No.: PCT/IB2014/001231

§ 371 Date: Dec. 1, 2015

(30) Foreign Application Priority Data
Jul. 1, 2013 (IT) AR2013A000023

(51) Int. Cl. H01Q 3/46; H01Q 15/08; H04B 1/40

(52) U.S. Cl. CPC H01Q 3/46; H04B 1/40; H01Q 15/08

(57) ABSTRACT

The electromagnetic radiation carries both energy and angular momentum. The angular momentum can be divided into the components “Spin Angular Momentum” (i.e. the polarization) and “Orbital Angular Momentum” (OAM). The use of radiation with OAM can allow a more efficient utilization of the radio spectrum for example by means of the re-use of the same radiation frequency with different OAM modes. The present invention concerns the definition of devices, systems and methods for the generation of OAM modes in the radiation. For this purpose it has been proposed the use of one or more lenses which have a suitable distribution of refraction properties in order to generate OAM in the radiation which passes through them. The proposed lens can be composed of standard dielectric materials or of metamaterials with predetermined physical characteristics or also of tunable metamaterials for an appropriate modulation of the lens properties.

### FIELD OF THE INVENTION

The present invention is applicable to innovative radio frequency communication systems and in particular to the generation—in the electromagnetic radiation—of orbital angular momentum (OAM) by means of a “lens” with a suitable distribution of refraction characteristics.

### BACKGROUND

The classical theory of electromagnetism shows that electromagnetic radiation carries both energy and angular momentum. The angular momentum can be divided into SAM (Spin Angular Momentum) component, that is the polarization, and the OAM (Orbital Angular Momentum) component.

The use of OAM in radio-frequency and its practical implications have been recently analyzed (Thidè B., H. Then, J. Sj Oholm, K. Palmer, J E S Bergman, T D Carozzi, Y N Istomin, N H Ibragimov, and R. Khamitova, “Utilization of photon orbital angular momentum in the low-frequency radio domain”, Phys. Rev. Lett, vol. 99, no. 8, p. 087701, 22 Aug. 2007). The OAM modes are generated by the rotation of the phase front of the radiation, therefore the radiation is just “twisted” around the direction of propagation in the manner shown in FIG. 1, FIG. 2, FIG. 3, FIG. 4.

More specifically, FIG. 1 represents a radiation in the absence of OAM modes (m=0), the FIGS. 2, 3 and 4 represent radiation with OAM modes (respectively, m=1, m=2, m=3). The parameter “m” is the number that identifies the OAM modes and is a notation borrowed by quantum mechanics where “m” is in fact the quantum number corresponding to the orbital angular momentum.

Therefore, in order to generate radiation with OAM it must be created an appropriate phase shift between different components of the radiation in such a manner as to generate just the rotation of the phase front.

With the proliferation of telecommunications systems and radar much more radio frequency bands are required in order not to limit their further development. The use of a radiation new feature as the OAM, may allow an increase of radio frequency bands exploitation through a more efficient use of spectrum availability (e.g. by reusing the same frequency with different OAM modes).

This raises the need to implement new telecommunications systems and antennas, suitably versatile and capable of generating (and receiving) electromagnetic waves provided with OAM. In the present invention it has been proposed to use a particular lens, composed by a material with a refractive index spatially and suitably distributed in order to delay the incident radiation phase in such a way the required OAM modes can be generated both with m>0 (clockwise winding) and with m<0 (anti-clockwise winding).

### SUMMARY

Purpose of the present invention is to develop a system that allows the generation and reception of electromagnetic radiation with OAM.

Radiation OAM can be generated either by combining the radiation from different sources with an appropriate periodical time delay or by introducing an appropriate periodic spatial phase shift in the radiation. This second method has been considered for the definition of the present invention.

To this end it has been identified a lens to position in correspondence of the radiating element of an antenna or transversally in a waveguide in order to create a phase shift of the incident wave to generate a wave front motion following to a helical shape which is the peculiar characteristic of the radiation with OAM.

Similarly to the case which involves the generation of OAM modes (e.g. m>0), the lens may act in an opposite way generating OAM modes of opposite sign (e.g. m <0) and then subtracting orbital angular momentum by a radiation with positive OAM. The result can be to eliminate or to reduce the OAM modes of an incoming radiation.

The proposed lens can be of any type and shape (e.g. concave, convex, flat, spherical, aspherical, etc . . . ) depending on the specific practical needs (i.e. convergent or divergent beam, etc.). For the sake of descriptive clarity, in the present patent it has been considered the simple case of a flat lens with cylindrical shape bearing in mind that the considerations made for such a lens can be extended to other types of lens.

The lens can be composed of a traditional material (dielectric) or a metamaterial with a distribution of refractive index to generate a phase shift and then a rotation of the phase front. It is well known that the properties of a dielectric such as permittivity and permeability can be modeled using LC circuits distributed. In this case, the metamaterial is constituted by a matrix of circuits with capacitive elements (to reproduce the electric permittivity “ε”) and inductive elements (to reproduce the magnetic permeability “μ”).

A known example of a metamaterial can be represented by systems based on “split-ring resonators” (FIG. 5) which is composed of arrays of circuits called precisely split-rings.

The use of metamaterials can be an advantage compared to conventional materials because the characteristics of permittivity and permeability—and then the lens refractive index “n” (n=\sqrt{ε′μ})—can be selected and spatially distributed in the suitable way.

To understand the relationship between the shape of the phase front and the presence of OAM modes, we can start from the wave equation in its most general form in three dimensions:

$${∇}^{2} ψ - \frac{1}{{v}^{2}} \frac{{\partial }^{2}}{\partial {t}^{2}} ψ = 0 \qquad ( 1 )$$

Assuming it is possible to factorize the spatial part and the time part, the wave function can be rewritten as

Ψ(x, y, z, t)=ε₀(x, y, z)e^{-(kz-ωt)}

For a directional beam (e.g. concentrated beam or laser) where the intensity of radiation is confined in the vicinity of the axis of propagation z, the “paraxial” wave equation approximation can be used. This approximation is applicable for a so-called “Gaussian” beam where the radiation intensity follows a Gaussian profile relative to the direction of propagation. With the mentioned approximations the wave equation is then:

$$\frac{{\partial }^{2}}{\partial {x}^{2}} {ɛ}_{0} ( x , y , z ) + \frac{{\partial }^{2}}{\partial {y}^{2}} {ɛ}_{0} ( x , y , z ) + 2 i k \frac{\partial }{\partial z} {ɛ}_{0} ( x , y , z ) = 0 \qquad ( 2 )$$

The general solution in cylindrical coordinates (p, θ, z) is:

$${ɛ}_{p , m} ( ρ , ϑ , z ) = \frac{A}{w} {( \frac{\sqrt{2} ρ}{w} )}^{2} {L}_{p}^{m} ( \frac{2 {ρ}^{2}}{{w}^{2}} ) {e}^{\frac{{ρ}^{2}}{{w}^{2}}} {e}^{\frac{i k {p}^{2}}{2 R}} {e}^{- i m θ} \qquad ( 3 )$$

Where:
Lₚ^{m} is the Laguerre function. “m” e “p” are the indices of azimuth (θ) and radial (ρ) modes respectively. For the analysis of the OAM modes only the azimuthal modes are of interest and therefore we consider only the case with index p=0. It must be pointed out that for any value of m and x the function of Laguerre L₀^{m}(x)=1
w is proportional to the beam width (distance from the axis z for which the amplitude value is decreased by 1/e)
k=2 π/λ is the wave number, where λ is the wavelength of the used radiation
R is the radius of the wavefront curvature.

So the complete solution of the wave equation is:

$$ψ ( ρ , ϑ , z , t ) = \frac{A}{w} {( \frac{\sqrt{2} ρ}{w} )}^{2} {e}^{- \frac{{ρ}^{2}}{{w}^{2}}} {e}^{- \frac{i k {ρ}^{2}}{2 R}} {e}^{- i m ϑ} {e}^{- i ( k z - ω t )} \qquad ( 4 )$$

The first three factors characterizing the amplitude of the radiation while the second three factors characterizes the phase value.

Neglecting, in first approximation, the curvature of the phase front (then R→∞) it comes out that because of the presence of the “m·θ” term, the phase front has a helical shape with pitch=m·λ (wavelength λ=2π/k).

To generate the helical motion in the radiation it is proposed to use a lens with a refractive index increasing along the azimuth θ (azimuth is defined with respect to the wave propagation direction). The part of the lens with higher refraction index slows down the radiation with the effect of delaying progressively along θ the radiation phase and then determining phase-front progress with a helical shape (generation of OAM modes).

Finally, we must identify a possible criterion for defining the appropriate distribution of the refractive indexes values in the lens in order to generate the desired OAM modes.

Let us consider to use a cylindrical lens divided into segments, like “cake-slices”, of materials with refractive indexes increasing in the azimuthal direction (FIG. 9).

The radiation speed in a medium is given by v=c/n (Snell's law refraction law) where c is the speed of the radiation in vacuum and n is the refractive index of the medium.

Radiation slowing down is then proportional to the refractive index values of the different lens slices (higher refractive indexes lead to higher slowing down).

As already stated the “pitch” of the helix described by an OAM radiation wave-front is equal to m·λ and therefore it must be imposed that the phase delay is equal to the pitch of the helix. Considering a lens of thickness d, it results that the value of refractive index in each segment will be equal to:

$${n}_{i} = 1 + \frac{λ}{d} \cdot \frac{m \cdot {ϑ}_{i}}{2 π} \qquad ( 5 )$$

If, for example, it is considered a lens of thickness of 2·λ composed of 6 slices (then azimuth discrete values are θᵢ=(i−1)·π/3 with i ranging from 1 to 6) and OAM modes with m=1, the values of the refractive index will be

| θᵢ | 0 | π/3 | 2π/3 | π | 4π/3 | 5π/3 |
|---|---|---|---|---|---|---|
| nᵢ | 1 | 1.083 | 1.166 | 1.25 | 1.333 | 1.416 |

It is pointed out that for OAM generation it is possible to act both on the lens thickness and on refractive index vales.

It results for example that, given a set of refractive index values for any slice, a lens thickness increase leads to OAM modes with upper indexes m.

The above identified criterion for lens composition and refractive index distribution (defined in formula 5) is only one possible example and other criteria may be identified.

Similarly, beyond the discrete case, it can be considered a lens with a continuous increase of refractive index along azimuthal direction. In this case refractive index distribution can follow the rule:

$$n ( ϑ ) = 1 + \frac{λ}{d} \cdot \frac{m \cdot ϑ}{2 π} \qquad ( 6 )$$

### BRIEF DESCRIPTION OF THE DRAWINGS

FIGS. 1, 2, 3, 4 illustrate radiations with different value of OAM.

FIG. 5 shows an example of a metamaterial with configurable electromagnetic properties according to the dimensioning of the constituent elements (matrix of Split Ring Resonators).

FIG. 6 shows the generation of OAM modes in a radiation passing through a lens with a refractive index increasing in the azimuthal direction.

FIG. 7 shows the generation of OAM modes in a radiation passing through a multi-lens system.

FIG. 8 shows the subtractions of OAM modes in a radiation by means the passage through a lens with a refractive index decreasing in the azimuthal direction (opposite to the direction of FIG. 6).

FIG. 9 shows the scheme for the generation of OAM in the transmitting radiation and the OAM elimination in the receiving radiation.

FIG. 10 shows the way to generate OAM modes through cylindrical lens composed by slices of material with increasing refractive index in the azimuthal direction.

FIG. 11 shows an example of a metamaterial with reconfigurable physical properties (array of capacitors with a capacity adjustable by varicap diodes).

FIG. 12 shows the functional scheme for the system equipped with a tunable lens.

FIG. 13 shows the radio communication system composed of a directive antenna equipped with lens for the generation of OAM modes.

FIG. 14 shows the radio communication system composed of a waveguide equipped with lens for the generation of OAM modes.

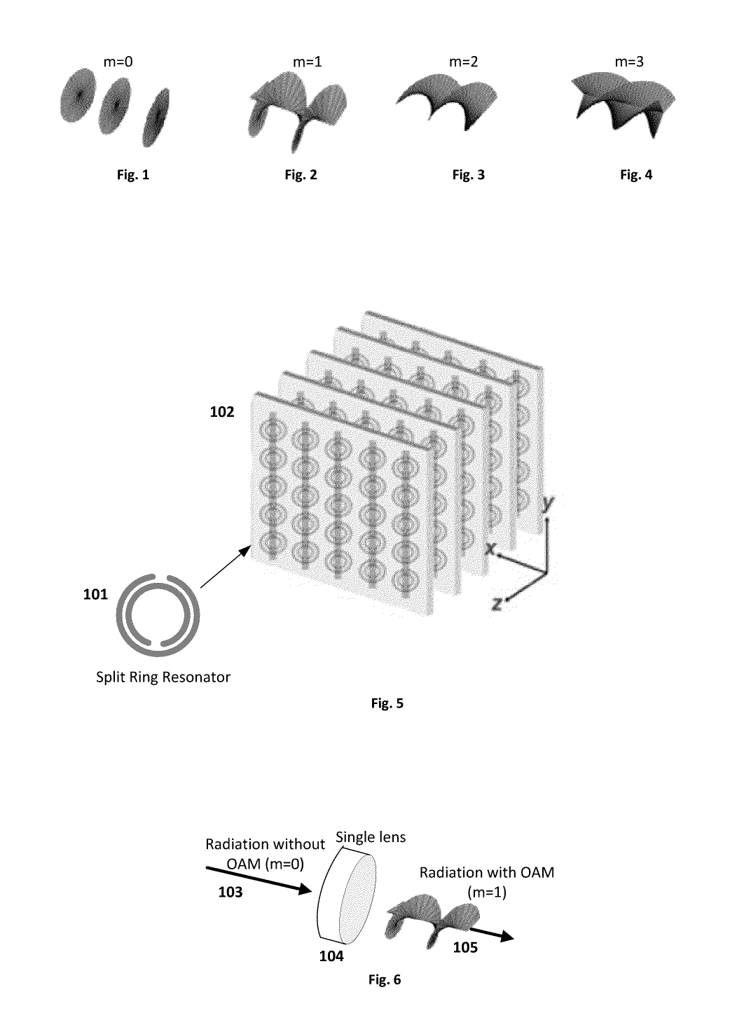

### DESCRIPTION

The proposed basic system (FIG. 6) is composed by a lens (104) with a refractive index “n” growing in azimuthal direction, and an incoming radiation (103) which passes through this lens (104). The effect of the lens (104) is to generate OAM modes in the outgoing radiation (105). The OAM index will be a function of the distribution of “n” and the thickness of the lens.

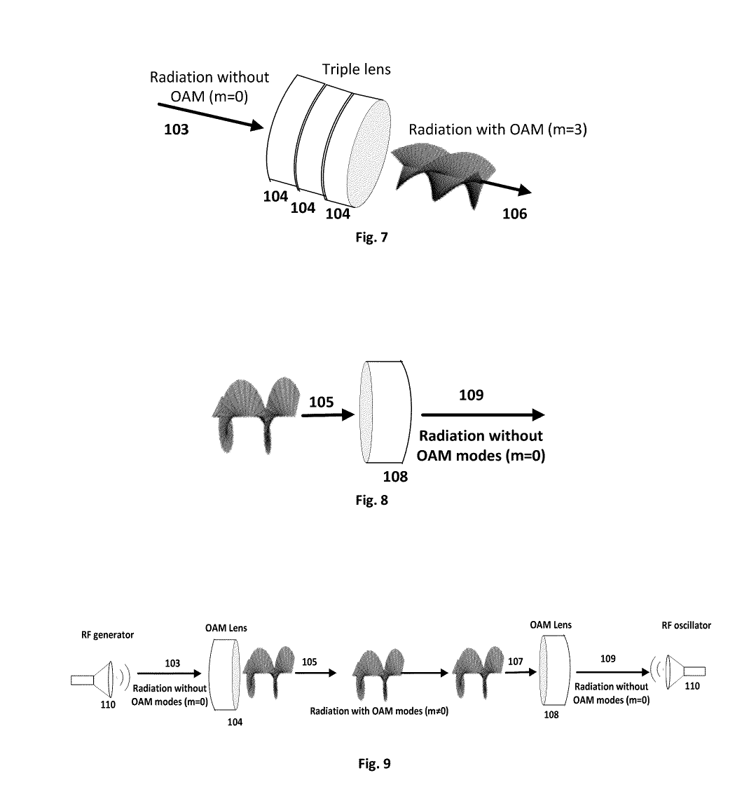

The system can also be composed of a variable number of “stacked” lenses (104) (FIG. 7) to generate OAM modes in the outgoing radiation (106) with indices which is a multiple of that obtained with single lens system.

Obviously, as shown in FIG. 8, a lens (108) can act in the opposite way by subtracting OAM modes (that is adding OAM of opposite sign) from an incoming radiation (107) which is provided with them.

FIG. 9 shows the functionality provided by the proposed lenses:
during the transmission phase, generate OAM modes (105) in a radiation originally with no OAM modes (103);
to propagate the signal carrier with OAM modes (105 and 107). This signal will not interfere with other signals which have the same frequency and polarity because they have different OAM modes;
to remove the OAM modes from radiation in reception in order to deliver to the receiver a radiation with no OAM modes (109).

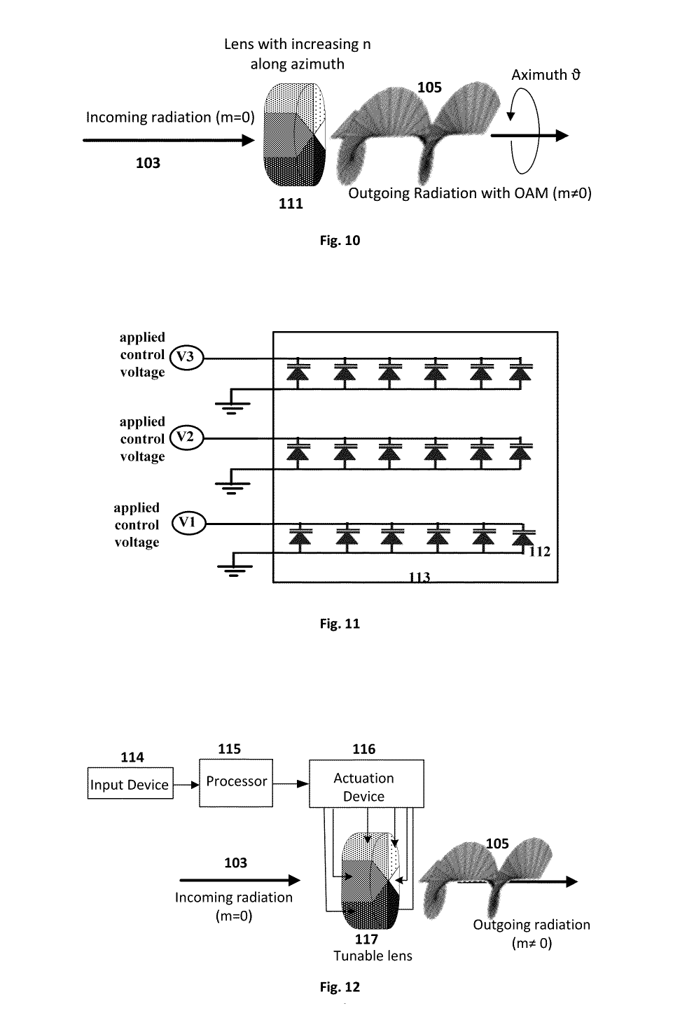

One of the possible composition of the lens (and the related distribution of refractive index) is shown in FIG. 10. The lens (111) is divided into a number of “slices” with increasing refractive index. The correct value of refractive index for each segment depends on the desired OAM mode and the wavelength of the radiation, according with the formula (5).

It is also possible to assume a distribution of refractive index made by a continuous increase along the azimuthal direction and this can be ruled by the formula (6).

More in detail, the lens may consist of:
A. traditional material (e.g. polystyrene, polyethylene) with a distribution of predetermined refractive properties;
B. metamaterial with predetermined refractive properties distributed in an appropriate way such as a matrix (102) of Split Ring Resonators (101) like the one shown in FIG. 5
C. Tunable metamaterial with reconfigurable refractive properties to allow the use of different frequencies and to generate different OAM modes.

The lenses of type A and B are “static” with predetermined physical characteristics (distribution of refractive index and thickness) for a certain wavelength. They can be used—if interposed in the optical path of a radiation—to generate or to eliminate OAM modes in the incoming beam.

The lens of type C allows to set the physical characteristics of the lens itself (basically, the distribution of the refractive index) to generate different OAM modes for different wavelengths. Secondly, this type of lens may allow a modulation of the OAM modes obtaining an increase of the “states” of the signal and therefore more information and data can be transmitted.

The modulation of the parameters of the lens may be obtained by acting on the various elements of the metamaterial (e.g. LC circuits), determining the physical characteristics of permittivity and permeability, and thus the index of refraction.

There are several ways to modulate the physical characteristics of a metamaterial. One option consists of a matrix of capacitive elements with tunable capacity as, for example, the “varactors” (or “varicap” diode), a particular electronic components with variable capacitance. A diode “varicap” is then a capacitor with variable capacitance that can be modulated by adjusting the reverse bias voltage of the diode. An example of varicap-based tunable metamaterial is shown in the schematic layout of FIG. 11.

Another possibility consists of the use of ferroelectric material. The ferroelectricity is a property of some solid materials (such as crystals and ceramic materials). These materials are polarized by the application of an electric field and maintain the polarization even after turning off of the electric field itself. The polarization, and therefore both the permittivity and the index of refraction of the material, depends on the electric field applied to the material and in this way it can be modulated

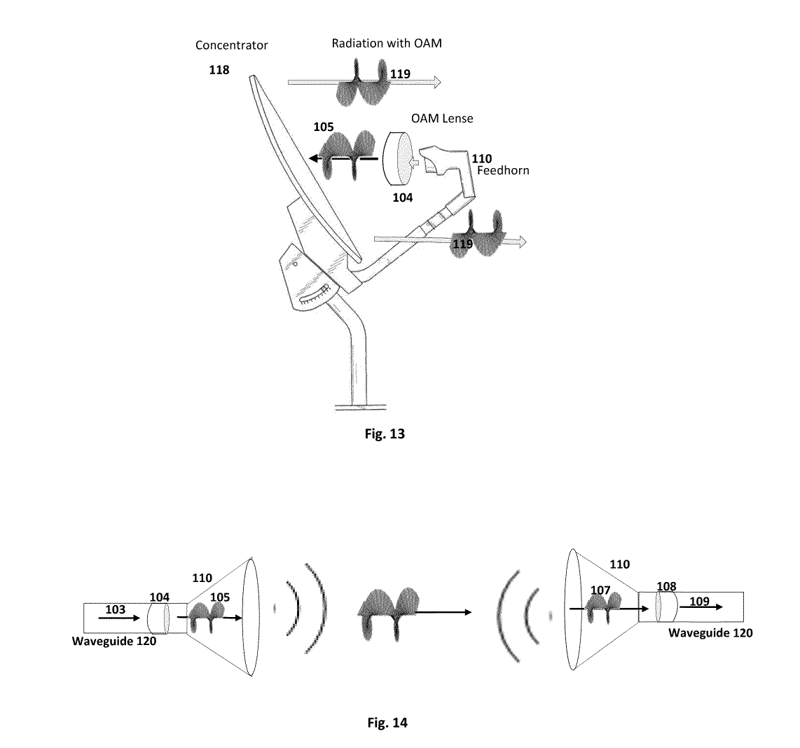

In conclusion, the whole communications system (FIG. 13) is composed by:
radiating element and feedhorn (110);
lens to generate/eliminate OAM modes (104) from the transmitting or receiving radiation;
radiation concentrator (118)

As an alternative to the system described in FIG. 14, it is possible to accommodate the lens (104) in a waveguide (120). The lens (104) is oriented transversally with respect to the wave propagation direction as shown in FIG. 14. In this way the radiation is already provided with OAM when it leaves the feed (110).

In the particular case of lens constituted by metamaterial with tunable and programmable characteristics (FIG. 12) it will be required to provide also:
one or more input devices (114) to set the required characteristics of the outgoing radiation (e.g. required OAM modes);
a software for the conversion of input signals in the commands necessary to set the physical characteristics of the lens (i.e. the distribution of the refractive indices in the material);
a processor (115) to process the input data and define the required commands
A series of actuators/commands (116)—as for example digital potentiometers—operating on the components of the metamaterial lens to set the refraction characteristics.

1. A device consisting of a lens for OAM generation in a radiation, made of a suitable material and characterized by:
a) a shape of a solid of revolution with the revolution axis parallel to the radiation direction of propagation;
b) a refractive index gradient along the revolution direction (azimuth) that is the direction perpendicular to the rotation axis and the radial direction (see FIG. 10) with a value proportional to the used radiation wavelength and the desired OAM modes and inversely proportional to the lens thickness (formula 5 and 6 of the Description);
c) A thickness depending on used radiation wavelength and on desired OAM modes but not below the used radiation wavelength.

2. The device of claim 1) wherein the lens is made of a standard dielectric material.

3. The device of claim 1) wherein the lens is made of a metamaterial.

4. A device composed of lenses, as defiled in claim 1, stacked in series along the revolution axis direction.

5. The device of claim 1) wherein the lens is made of a tunable metamaterial.

6. A system composed of:
a) a device as defiled in claim 5;
b) an input device (e.g. keyboard) to set the characteristics of radiation output from the device as defined in claim 5;
c) a processor and software to process the input data and define the values and the distribution of the refractive indices of the device as defined in claim 5;
d) an actuation device capable of providing commands (e.g. voltage level to be applied) to configure the refractive index characteristics of the lens.

7. A transmitting/receiving communication system consisting of:
a) radiating element;
b) radiation concentrator;
c) device for the generation of OAM modes as defined in claim 1 or in claim 2 or in claim 3 or in claim 4 or in claim 5 or in the system defined in claim 6.

8. A system consisting of a waveguide for radio communication, accommodating a device as defined in claim 1 or in claim 2 or in claim 3 or in claim 4 or in claim 5 or in the system defined in claim 6 (in FIG. 14).

9. A method for OAM modes generation in a radiation by forcing the radiation itself to pass through a lens as defined in claim 1 or in claim 2 or in claim 3 or in claim 4 or in claim 5.
